(19) United States
(12) Patent Application Publication
(10) Pub. No.: US 2006/0226182 A1
(43) Pub. Date: Oct. 12, 2006

(54) Transformable holster

(76) Inventor: Edbert R. Dittmar, Gilbert, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/103,934

(22) Filed: Apr. 12, 2005

(51) Int. Cl. A01K 97/04; A45C 15/00; A45F 4/00

(52) U.S. Cl. 224/197; 224/575; 224/581; 224/676

(57) ABSTRACT

A transformable holster (10) for a portable product (12) can include a lower base portion (22) having a receptacle for receiving a lower portion of the portable product, and an upper base portion (14) coupled to the lower base portion. The lower base portion moves relative to the upper base portion and the transformable holster can transform into a compact holster when the upper base portion is detached from the portable product. The holster can optionally include an intermediary portion (20) pivotably hinged to the lower base portion and the upper base portion and a biasing member such as one or more spring loaded pivot joints (17 and/or 19). In one alternative (70) using a dove tail arrangement, one among an upper base portion (72) and the lower base portion (74) can slide into each other to form the compact holster.

### FIELD OF THE INVENTION

This invention relates generally to holsters, and more particularly to a folding holster used for portable products.

### BACKGROUND OF THE INVENTION

Monolith shaped portable products and particularly ruggedized monolith shaped phones are typically accompanied by large and bulky holsters that are uncomfortable to wear in a seated position. These large and bulky holsters remain uncomfortable in a seated position even when a user removes the portable product from their holster. These existing holsters fail to accommodate for the day to day positioning users experience while wearing these holsters (with or without the accompanying portable product within such holsters).

### SUMMARY OF THE INVENTION

Embodiments in accordance with the present invention can provide a portable product holster that transforms into a compact shape. The compact shape can accommodate users whether they are standing up or sitting down and is less bulky than the typical holster, particularly when transformed into the compact shape.

In a first embodiment of the present invention, a transformable holster for a portable product can include a lower base portion having a receptacle for receiving a lower portion of the portable product, and an upper base portion coupled to the lower base portion. The lower base portion moves relative to the upper base portion and the transformable holster can transform into a compact holster when the upper base portion is detached from the portable product. The holster can further optionally include an intermediary portion pivotably hinged to the lower base portion and the upper base portion and a biasing member for biasing the holster in a folded state to form the compact holster. The biasing member can be at least one spring loaded pivot joint. The biasing member can alternatively be used for biasing into each other at least one among the upper base portion and the lower base portion. In one alternative, one among the upper base portion and the lower base portion can slide into each other to form the compact holster. For example, the upper base portion and the lower base portion can form a sliding dovetail arrangement enabling the upper base portion and the lower base portion to slide into each other to form the compact holster. Note, the transformable holster can further include a spring loaded clip coupled to the upper base portion. Also note that the transformable holster in the form of the compact holster can hold the portable product in the receptacle of the lower base portion.

In a second embodiment of the present invention, a folding holster for a portable product can include a lower base portion, an upper base portion where the lower base portion moves relative to the upper base portion, and an intermediary portion pivotably hinged to the lower base portion and the upper base portion. The folding holster can further include a biasing member for biasing the holster into a folded state such as one or more spring loaded pivot joints. A first spring loaded pivot joint can be between the lower base portion and the intermediary portion and a second spring loaded pivot joint can be between the intermediary portion and the upper base portion.

In a third embodiment of the present invention, a sliding holster can include a lower base portion and an upper base portion where the lower base portion slides relative to the upper base portion forming a full size holster in first position and a compact holster in a second position. The sliding holster can further include a biasing member for biasing the holster towards the first position to form the full size holster such as one or more spring loaded members for biasing the upper base portion and the lower base portion away from each other. Note, the upper base portion and the lower base portion can form a sliding dovetail arrangement enabling the upper base portion and the lower base portion to slide into each other to form the compact holster. The upper base portion and the lower base portion can also slide into each other into a locked position when forming the compact holster. Further note, the sliding holster in the form of the compact holster can hold a portable product in a receptacle of the lower base portion.

### BRIEF DESCRIPTION OF THE DRAWINGS

FIG. 1 is a perspective view of a transformable holster in first position capable of holding portable product in accordance with an embodiment of the present invention.

FIG. 2 is a side view of the transformable holster of FIG. 1 in accordance with an embodiment of the present invention.

FIG. 3 is a side view of the transformable holster of FIG. 1 further including a portable product in accordance with an embodiment of the present invention.

FIG. 4 is another illustration of the transformable holster of FIG. 1 in transition from a first position to a second position or compact holster in accordance with an embodiment of the present invention.

FIG. 5 is a side view of a transformable holster similar to FIG. 4 further including an elastic biasing member and a portable product in accordance with an alternative embodiment of the present invention.

FIG. 6 is a perspective view of the transformable holster of FIG. 1 in a second or compact position in accordance with an embodiment of the present invention.

FIG. 7 is a side view of the transformable holster of FIG. 6 further including a portable product carried by the holster in accordance with an embodiment of the present invention.

FIG. 8 is a perspective view of a transformable sliding holster in a first or expanded position in accordance with an embodiment of the present invention.

FIG. 9 is a perspective view of the transformable sliding holster of FIG. 8 further including a portable product therein in accordance with an embodiment of the present invention.

FIG. 10 is a perspective view of the transformable sliding holster of FIG. 8 in a second or compact position in accordance with an embodiment of the present invention.

FIG. 11 is a perspective view of the transformable sliding holster of FIG. 10 further including a portable product therein in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

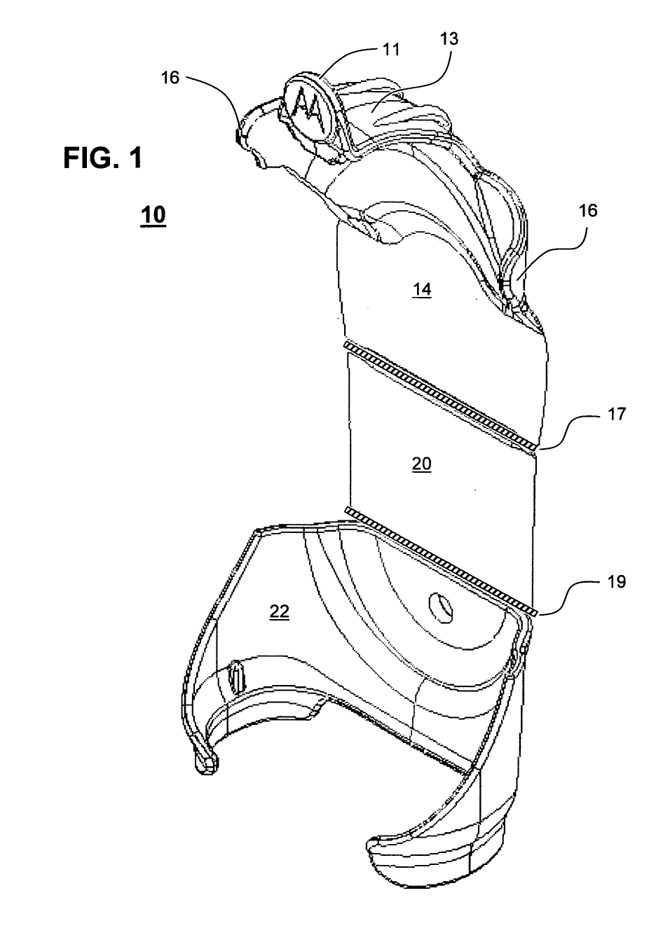

Referring to FIGS. 1-7 and FIGS. 8-11, a transformable holster in accordance with embodiments of the invention can transform from a first or extended position to a second or compact position. Such arrangement can help minimize the size of the holster when a portable product carried by the holster is at least partially removed or completely removed from the holster. The portable product carried by the transformable holster is not necessarily limited to a portable or mobile radio as shown herein, but can be any portable product such as a personal digital assistant, a voltmeter, a global positioning device, a gaming device, a messaging device or any other electronic or non-electronic product or tool carried in a holster.

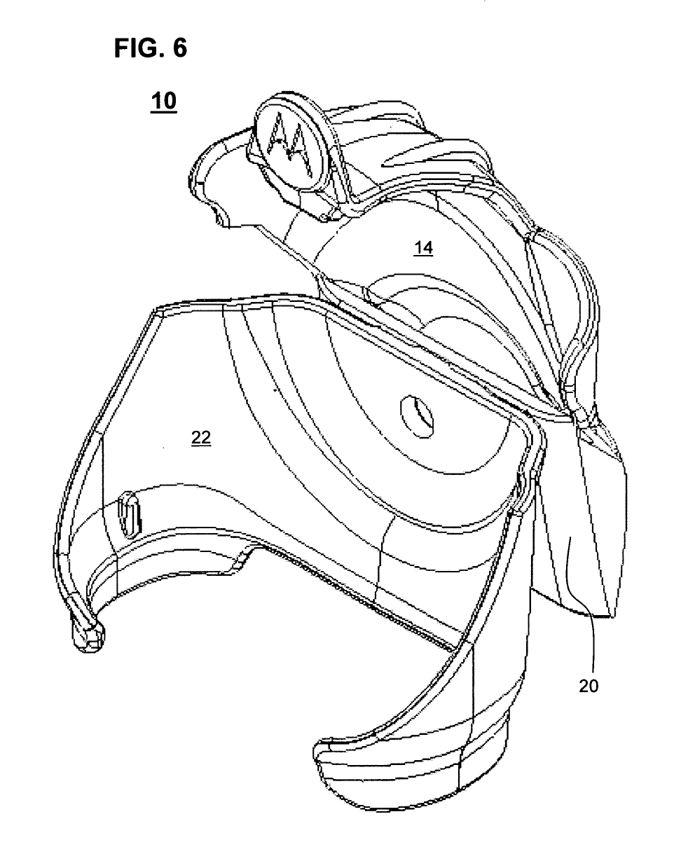

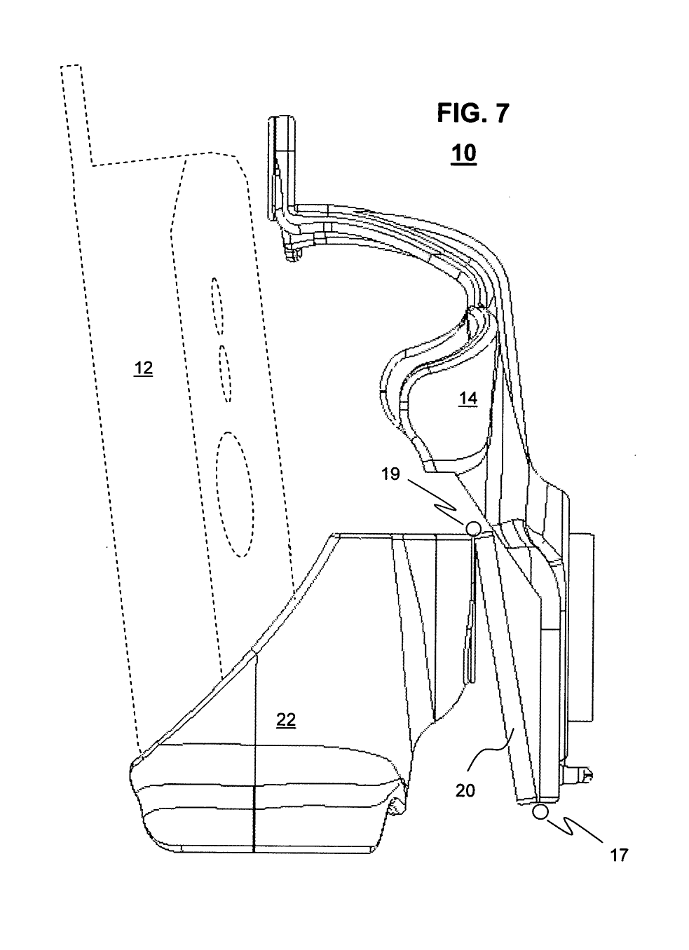

Referring to the embodiments of FIG. 1-7, a transformable holster 10 in the form of a folding holster can include a lower base portion 22 having a receptacle for receiving a lower portion of a portable product 12, and an upper base portion 14 coupled to the lower base portion 22. The lower base portion 22 moves relative to the upper base portion 14 and the transformable holster 10 can transform into a compact holster as shown in FIGS. 6 and 7 when the upper base portion 14 is detached from the portable product 12. More particularly, the upper base portion 14 can include flanges 16, a top portion 11, and a tab 13 that can facilitate the capture or removal of the upper base portion 14 from an upper portion of the portable product 12.

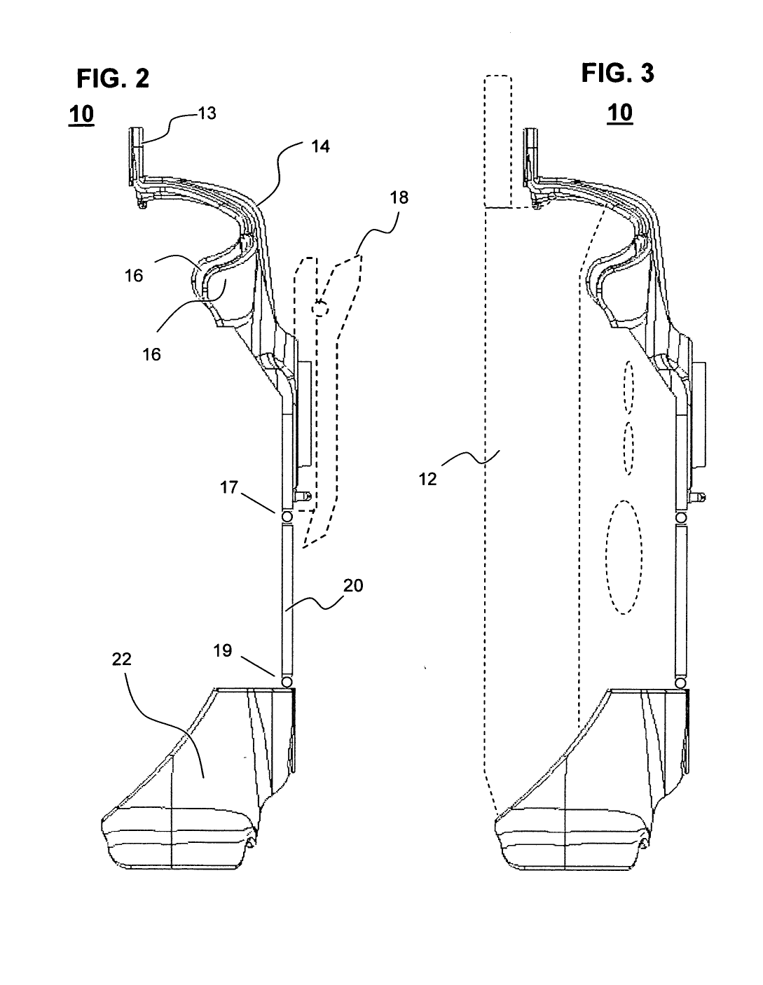

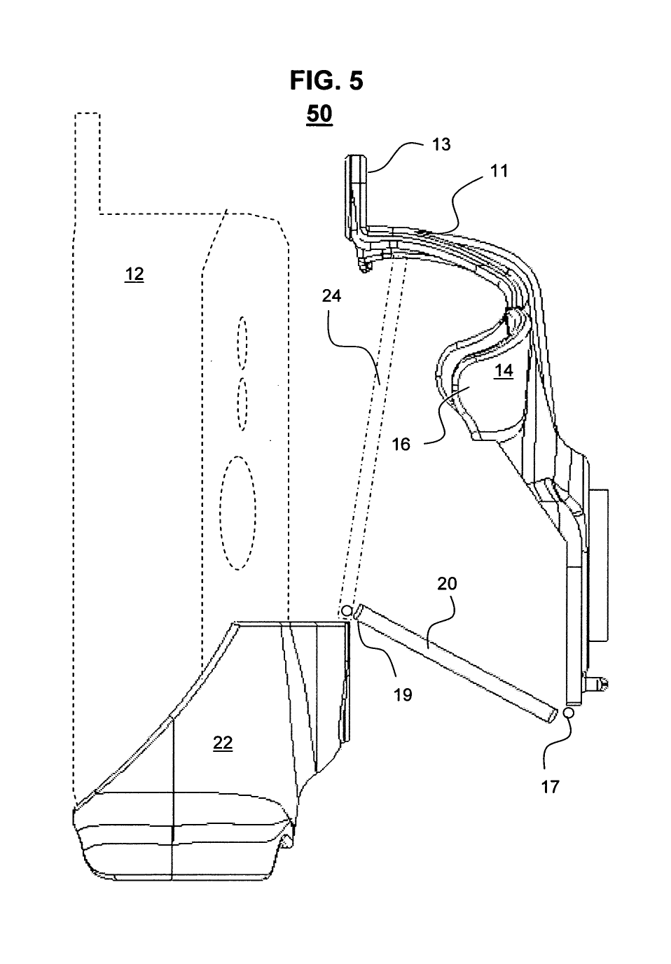

The transformable holster 10 can further optionally include an intermediary portion 20 pivotably hinged to the lower base portion 22 and the upper base portion 14 and at least one biasing member for biasing the holster in a folded state or position to form the compact holster. The biasing member can be at least one spring loaded pivot joint such as a first spring loaded pivot joint 19 interposed between the lower base portion 22 and the intermediary portion 20 and a second spring loaded pivot joint 17 interposed between the intermediary portion 20 and the upper base portion 14. The biasing member can alternatively be used for biasing into each other at least one among the upper base portion and the lower base portion. In one alternative, the biasing member can be an elastic member 24 as shown in the alternative transformable holster 50 of FIG. 5. Note, the transformable holster 10 can further include a spring loaded clip 18 coupled to the upper base portion 14 as shown in FIG. 2.

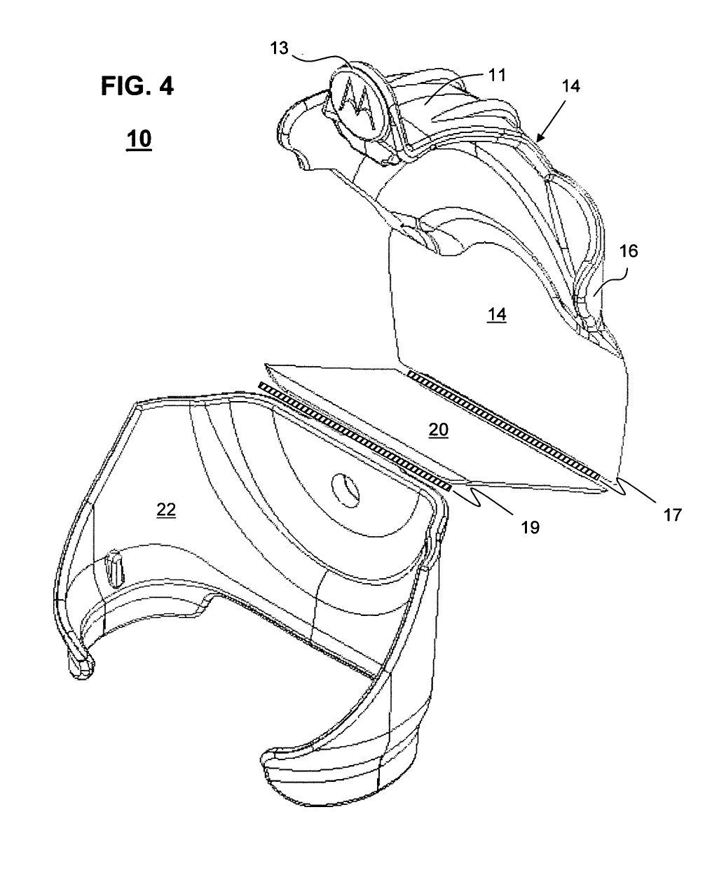

Operationally, once the portable product 12 is carried by the transformable holster 10 in an extended position as shown in FIG. 3, a small amount of force by a user on the tab 13 or the top portion 11 can cause the upper base portion 14 to slip off of the portable product 12. Referring to FIGS. 4 and 5, the transformable holster 10 (or 50) is shown in transition from the first or extended position to the second or compact position or form. Referring to FIGS. 6 and 7, the transformable holster 10 is shown in a second or compact form or position. Although not necessary, the transformable holster 10 can be biased (particularly when released from the portable product 12) towards the compact position by using any number of biasing members such as one or more spring loaded pivot joints (17 and/or 19) or elastic members (24). Also note that the transformable holster 10 in the form of the compact holster or in transition from one position to another can hold the portable product in the receptacle of the lower base portion 14 as shown in FIG. 5 or FIG. 7.

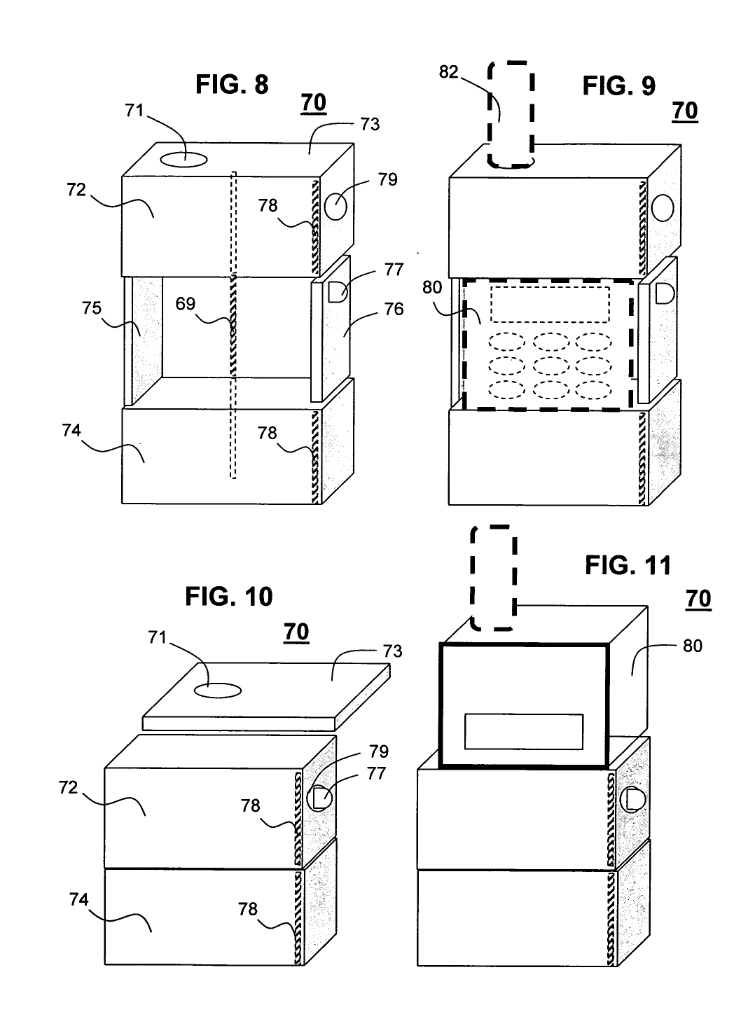

Referring to FIGS. 8-11, a transformable holster 70 in the form of a sliding holster can include a lower base portion 74 and an upper base portion 72 where the lower base portion 74 slides relative to the upper base portion 72 forming a full size holster in first position as shown in FIGS. 8 and 9 and a compact holster in a second position as shown in FIGS. 10 and 11. The upper base portion 72 can further include a lid 73 having an optional hole 71 and another hole 79 used as part of a locking feature. The lid 73 provides access to enable a portable product 80 to slide into and otherwise be carried by the sliding holster 70 as shown in FIG. 9. The hole 71 can receive protrusions such as an antenna 82 that might form a part of the portable product 80. The lid 73 can be hinged as shown in FIG. 10 or can alternatively be removed completely if needed.

The sliding holster 70 in one embodiment can further include a biasing member for biasing the holster towards the first position to form the full size or extended holster as shown in FIGS. 8 and 9. The biasing members can be one or more spring loaded members 78 for biasing the upper base portion 72 and the lower base portion 74 away from each other. Spring loaded members 78 can reside on opposing sides of an intermediary member 76. The intermediary member 76 can also include a protrusion 77 forming a part of the locking feature referenced above. In another alternative, another biasing member 69 on a back wall of the holster 70 can be used to bias the upper base portion 72 away from the lower base portion 74 (particularly if no intermediary member is used). Note, the upper base portion 72 and the lower base portion 74 can form a sliding dovetail arrangement enabling the upper base portion 72 and the lower base portion 74 to slide into each other along the surface of the intermediary member 76 (and other intermediary member 75) to form the compact holster. The upper base portion 72 and the lower base portion 74 can also slide into each other into a locked position when forming the compact holster using the locking feature of the hole in the upper base portion 72 and the protrusion 77 on the intermediary portion. Further note, the sliding holster 70 in the form of the compact holster as shown in FIG. 11 can hold the portable product 80 in a receptacle of the lower base portion 74.

In light of the foregoing description, it should also be recognized that embodiments in accordance with the present invention can be realized in numerous configurations contemplated to be within the scope and spirit of the claims. For example, embodiments herein can be formed with or without biasing members that bias the transformable holster into either an extended position or a compact position. As another example, the transformable holster could also be embodied with or without one or more intermediary members. In the embodiment of the sliding holster 70, no intermediary member (75 or 76) is necessary. In contrast, in the folding holster 10, such embodiments are not limited to just one intermediary member 20 as other intermediary members could also be used without departing from the scope and spirit of the claims. Additionally, the description above is intended by way of example only and is not intended to limit the present invention in any way, except as set forth in the following claims.

What is claimed is:

1. A transformable holster for a portable product, comprising:
a lower base portion having a receptacle for receiving a lower portion of the portable product; and
an upper base portion coupled to the lower base portion;
wherein the lower base portion moves relative to the upper base portion and the transformable holster can transform into a compact holster when the upper base portion detaches from the portable product.

2. The transformable holster of claim 1, wherein the transformable holster further comprises an intermediary portion pivotably hinged to the lower base portion and the upper base portion.

3. The transformable holster of claim 2, wherein the transformable holster further comprises a biasing member for biasing the holster in a folded state to form the compact holster.

4. The transformable holster of claim 3, wherein the biasing member comprises at least one spring loaded pivot joint.

5. The transformable holster of claim 1, wherein the transformable holster further comprises a biasing member for biasing into each other at least one among the upper base portion and the lower base portion.

6. The transformable holster of claim 5, wherein one among the upper base portion and the lower base portion slides into each other to form the compact holster.

7. The transformable holster of claim 5, wherein the upper base portion and the lower base portion form a sliding dovetail arrangement enabling the upper base portion and the lower base portion to slide into each other to form the compact holster.

8. The transformable holster of claim 1, wherein the transformable holster further comprises a spring loaded clip coupled to the upper base portion.

9. The transformable holster of claim 1, wherein the transformable holster in the form of the compact holster can hold the portable product in the receptacle of the lower base portion.

10. A folding holster for a portable product, comprising:
a lower base portion;
an upper base portion wherein the lower base portion moves relative to the upper base portion; and
an intermediary portion pivotably hinged to the lower base portion and the upper base portion.

11. The folding holster of claim 10, wherein the folding holster further comprises a biasing member for biasing the holster into a folded state.

12. The folding holster of claim 11, wherein the biasing member comprises at least one spring loaded pivot joint.

13. The folding holster of claim 11, wherein the biasing member comprises a first spring loaded pivot joint between the lower base portion and the intermediary portion and a second spring loaded pivot joint between the intermediary portion and the upper base portion.

14. The folding holster of claim 12, wherein the transformable holster further comprises a spring loaded clip coupled to the upper base portion.

15. A sliding holster, comprising:
a lower base portion;
an upper base portion wherein the lower base portion slides relative to the upper base portion forming a full size holster in first position and a compact holster in a second position.

16. The sliding holster of claim 15, wherein the sliding holster further comprises a biasing member for biasing the holster towards the first position to form the full size holster.

17. The sliding holster of claim 16, wherein the biasing member comprises at least one spring loaded member for biasing the upper base portion and the lower base portion away from each other.

18. The sliding holster of claim 16, wherein one among the upper base portion and the lower base portion slides into each other into a locked position when forming the compact holster.

19. The sliding holster of claim 16, wherein the upper base portion and the lower base portion form a sliding dovetail arrangement enabling the upper base portion and the lower base portion to slide into each other to form the compact holster.

20. The sliding holster of claim 16, wherein the sliding holster in the form of the compact holster can hold a portable product in a receptacle of the lower base portion.
